(19) United States
(12) Patent Application Publication
(10) Pub. No.: US 2013/0226820 A1
(43) Pub. Date: Aug. 29, 2013

(54) DETERMINING ADVOCACY METRICS BASED ON USER GENERATED CONTENT

(71) Applicant: BAZAARVOICE, INC., (US)

(72) Inventors: Donald J. Sedota, JR., Charleston, SC (US); Dustin G. Friesenhahn, Austin, TX (US); Brendan Sterne, Austin, TX (US)

(73) Assignee: BAZAARVOICE, INC., Austin, TX (US)

(21) Appl. No.: 13/769,639

(22) Filed: Feb. 18, 2013

Related U.S. Application Data
(60) Provisional application No. 61/599,789, filed on Feb. 16, 2012.
(60) Provisional application No. 61/599,796, filed on Feb. 16, 2012.

(51) Int. Cl. G06Q 30/02

(52) U.S. Cl. CPC G06Q 30/0282
USPC 705/319; 705/347

(57) ABSTRACT

Techniques for determining an advocacy metric for a particular person are described. User generated content (UGC) authored by the particular person may be received. Each of the plurality of UGC items may be associated with the particular person's opinion of a respective particular one of the plurality of goods or services. An advocacy metric, indicative of a degree of advocacy for the particular person, for the plurality of goods or services, may be determined for the particular person based on the plurality of UGC items.

### RELATED APPLICATIONS

This application claims the benefits of provisional applications U.S. 61/599,789 and 61/599,796, respectively titled “SYSTEM AND METHOD FOR CONSUMER ADVOCACY DETERMINATION BASED ON USER GENERATED CONTENT” and “SYSTEM AND METHOD FOR CONSUMER INFLUENCE DETERMINATION BASED ON USER GENERATED CONTENT”, both filed Feb. 16, 2012, which are herein both incorporated by reference in their entireties.

### BACKGROUND

This disclosure relates to processing user generated content (UGC), and more particularly, to assigning one or more metrics to a person, account, group of individuals, or other entity that has authored UGC or is otherwise associated with UGC that has been generated. Metrics assigned to a person (or other entity) may be indicative of that person's advocacy (i.e., propensity to recommend something) or influence (i.e., ability to affect the decisions of others).

In the world of commerce, a large number of UGC items may exist with regard to particular goods or services. These UGC items likewise may have been generated by a large number of different authors. Some of these authors may be highly influential, and a positive or negative review from such a person may affect future sales. Likewise, some of these authors may advocate strongly for (or against) particular brands or items. But without an ability to identify one or more persons, entities, etc., who may be strong advocates or top influencers, it may be impossible to take any effective action with regard to such persons or entities.

### BRIEF DESCRIPTION OF THE DRAWINGS

FIG. 1 is a block diagram of one embodiment of a system that is configured to collect and/or analyze user generated content.

FIG. 2 is a block diagram of one embodiment of a content distribution topology.

FIG. 3 is a block diagram of one embodiment of a data correlation topology that includes a data correlation system.

FIG. 4 is a diagram of one embodiment related to the correlation of user information (e.g., correlating user data from different sources).

FIG. 5 is a block diagram of one embodiment of a content intelligence topology including a content intelligence system 180.

FIG. 6A is a block diagram of one embodiment of an advocacy module.

FIG. 6B is a flow chart of one embodiment of a method related to determining an advocacy metric for a person.

FIG. 7A is a block diagram of one embodiment of an influence module.

FIG. 7B is a flow chart of one embodiment of a method related to determining an influence rating for a person.

FIGS. 8-10 are block diagrams of graphical user interface embodiments.

FIG. 11 is a depiction of one embodiment of an exemplary computer system.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The following paragraphs provide definitions and/or context for terms found in this disclosure (including the appended claims):

“Comprising.” This term is open-ended. As used herein, this term does not foreclose additional structure or steps. Consider a claim that recites: “a system comprising a processor and a memory . . . .” Such a claim does not foreclose the system from including additional components such as interface circuitry, a graphics processing unit (GPU), etc.

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation(s), etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue.

“First,” “Second,” etc. As used herein, these terms are used as labels for nouns that they precede unless otherwise noted, and do not imply any type of ordering (e.g., spatial, temporal, logical, etc.). For example, a “first” computing system and a “second” computing system can be used to refer to any two computing systems. In other words, “first” and “second” are descriptors.

“Based On” or “Based Upon.” As used herein, these terms are used to describe one or more factors that affect a determination. These terms do not foreclose additional factors that may affect a determination. That is, a determination may be solely based on the factor(s) stated or may be based on one or more factors in addition to the factor(s) stated. Consider the phrase “determining A based on B.” While B may be a factor that affects the determination of A, such a phrase does not foreclose the determination of A from also being based on C. In other instances, however, A may be determined based solely on B.

“Provider.” As used herein, this term includes its ordinary meaning and may refer, in various embodiments, to a manufacturer, offeror of services, restaurant, reseller, retailer, wholesaler, and/or distributor.

“User generated content” (UGC). As used herein, this term refers to text, audio, video, or another information carrying medium that is generated by a user who may be a consumer of something (e.g., of goods, a product, a website, a service), a purchaser of that something, or may otherwise have an interest in that something. User generated content includes, in various embodiments, user reviews, user stories, ratings, comments, problems, issues, questions, answers, opinions, or other types of content.

UGC may be received from a large variety of sources, including websites of providers (e.g., from a website on which goods are sold). UGC may also be displayed back to other users, thereby affecting their decisions to make a purchase or engage in other behaviors.

Techniques and structures described herein allow authors of particular UGC items to be identified as being influential and as being advocates or detractors. These authors may be identified in various fashions, and may have associated contact information such as an email address, phone number, user id, etc. As described below, authors may be analyzed for advocacy and influence with respect to particular brands, types of good or service, categories, and other factors.

Once identified, various actions may be taken with regard to such authors. Demographic data may be used—for example, if females 35-49 are identified as being the strongest advocates for a product, a marketer may wish to focus future advertising on this group. If a particular individual is identified as being a highly influential reviewer of digital cameras, a manufacturer or retailer may wish to give that individual a special opportunity to review an upcoming model, e.g., by shipping the author a free camera. Targeted coupons or a chance to participate in a focus group are other opportunities that might be offered to particular identified individuals. Likewise, a person (e.g., individual, group, etc.) identified as a strongly influential detractor (negative advocate) of a particular brand, for example, may be contacted by a provider in an attempt to improve the detractor's opinion by broadening the detractor's experience with the particular brand (e.g., by providing the detractor with coupons or free services) and/or to solicit feedback regarding possible improvements that could be made to the brand's products. Accordingly, once indications of advocacy and influence are determined for a person (e.g., by analyzing UGC items authored by that person), the resulting information may be used in a variety of different ways that may benefit a provider of goods or services, as well as individual authors of UGC.

Note that in this disclosure, advocacy and/or influence may be measured, calculated, analyzed, determined, etc., with respect (and without limitation) to any of: a product, a service, a brand, a type of product, a group of products (which may or may not be of the same type), a group of brands and/or services, a supplier, a manufacturer, a retailer, (e.g., any provider), and other objects, services, individuals, and entities. Thus, while specific examples or embodiments may be given herein that are described relative to only one of the listed categories above, it should be understood that such examples are non-limiting, and are generally applicable to other categories, objects, etc. Thus, a method or structure that is described in one embodiment only with respect to a product, for example, should be understood to also apply to other embodiments in regard to services, brands, types of products, etc., regardless of whether or not such other embodiments are specifically described. Also note that the term “may”, as used herein, should be understood to mean that the features, structures, and/or functionality being described are present in at least one embodiment, but that one or more other embodiments may exist in which such features, structures, and/or functionality are different or are not present. The lack of a qualifier (such as “may”), however, does not indicate that described features, structures, and/or functionality would be required or otherwise cannot be omitted in various embodiments. Furthermore, the term “person,” as used herein, may refer in various embodiments without limitation to a single individual, a group of two or more individuals, a corporation or other entity, or an account associated with any of the foregoing.

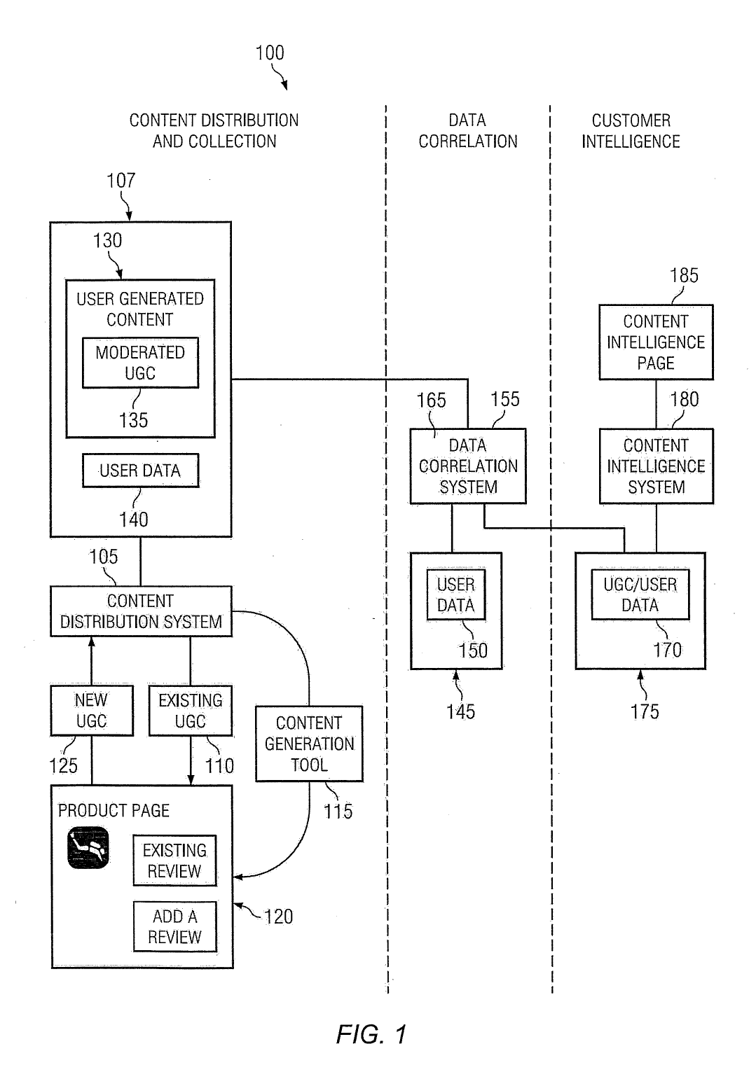

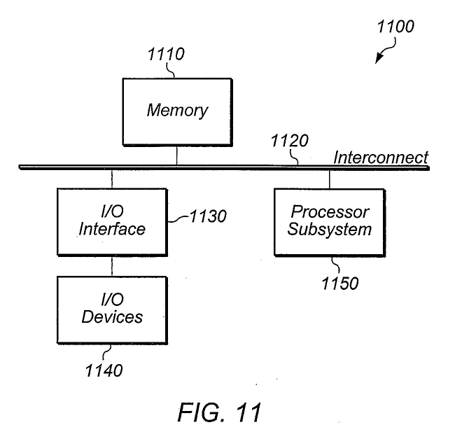

Turning now to FIG. 1, a block diagram is shown of one embodiment of a system 100 that is configured to collect and/or analyze user generated content. In one embodiment, system 100 is logically divided into a content distribution and collection portion, a data correlation portion and a content intelligence portion. However, in other embodiments, all or a portion of any of the systems and/or components shown as being in one of these portions may be logically placed in any other portion. That is, in various embodiments, all or a portion of any one of the systems and/or components depicted in FIG. 1 may be combined with one or more others of the systems/ and/or components shown. Thus, in one embodiment, data correlation system 155 may be combined with content intelligence system 180. In general, any of the systems or components described relative to FIG. 1 may be implemented, in various embodiments, by one or more instances of system 1100, or components thereof, as described relative to FIG. 11.

In the embodiment of FIG. 1, content distribution system 105 is configured to distribute and/or receive user generated content. Accordingly, content distribution system 105 may maintain a data store 107 that includes generated user generated content 130 from various sources. In some cases, user generated content may be moderated so that user generated content 130 includes moderated user generated content 135. Moderated content, in one embodiment, has been approved by an administrator and/or administrator software (e.g., determined not to be spam).

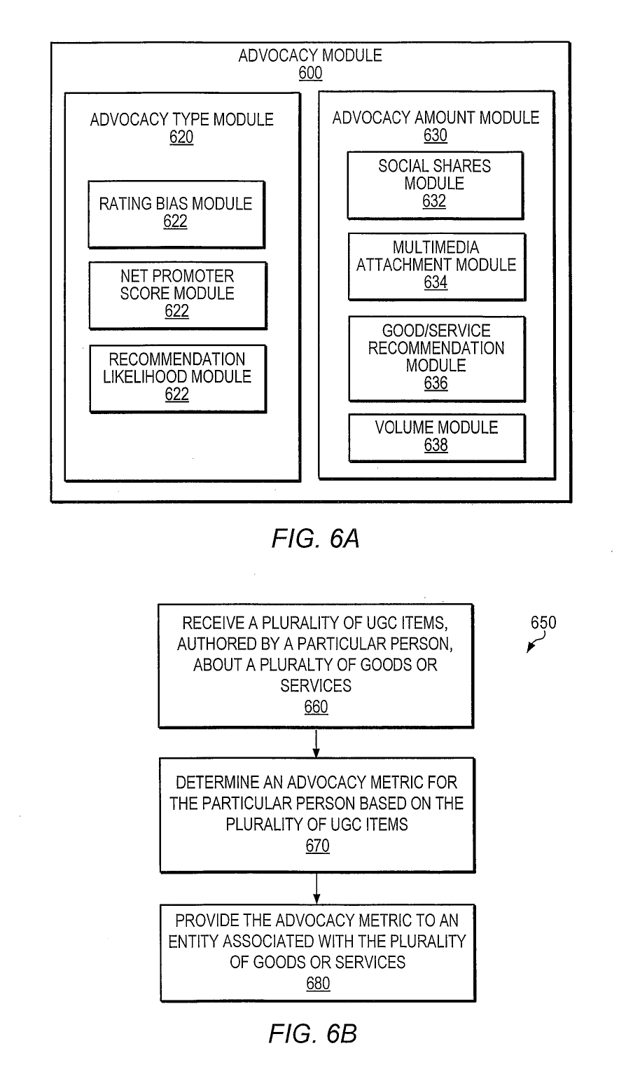

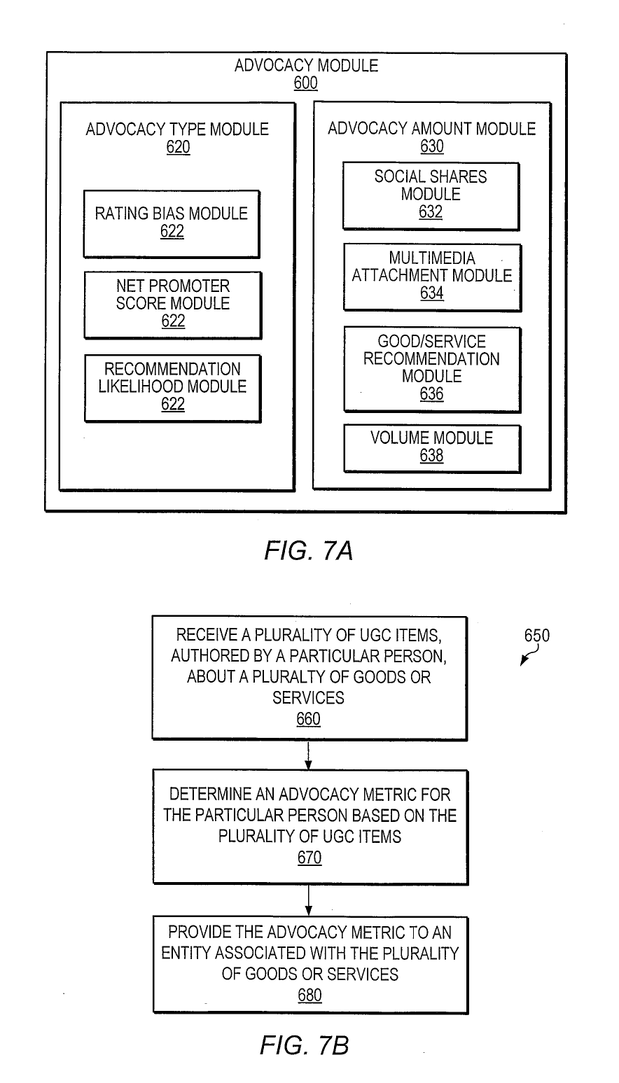

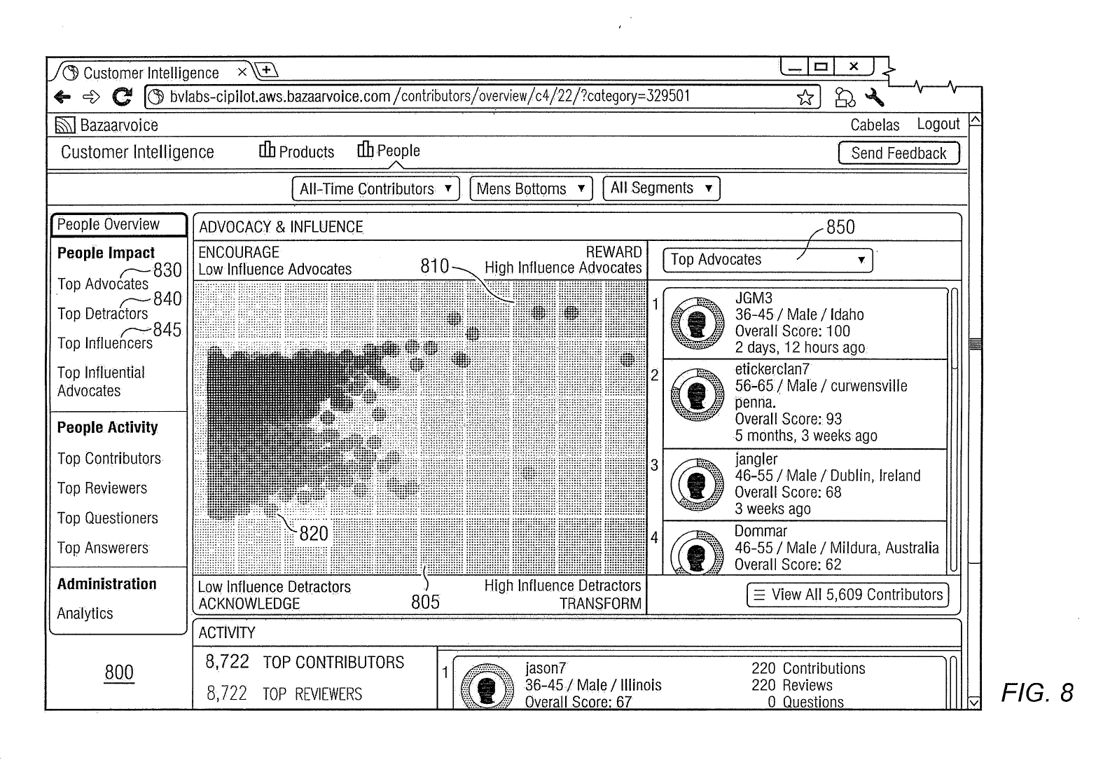

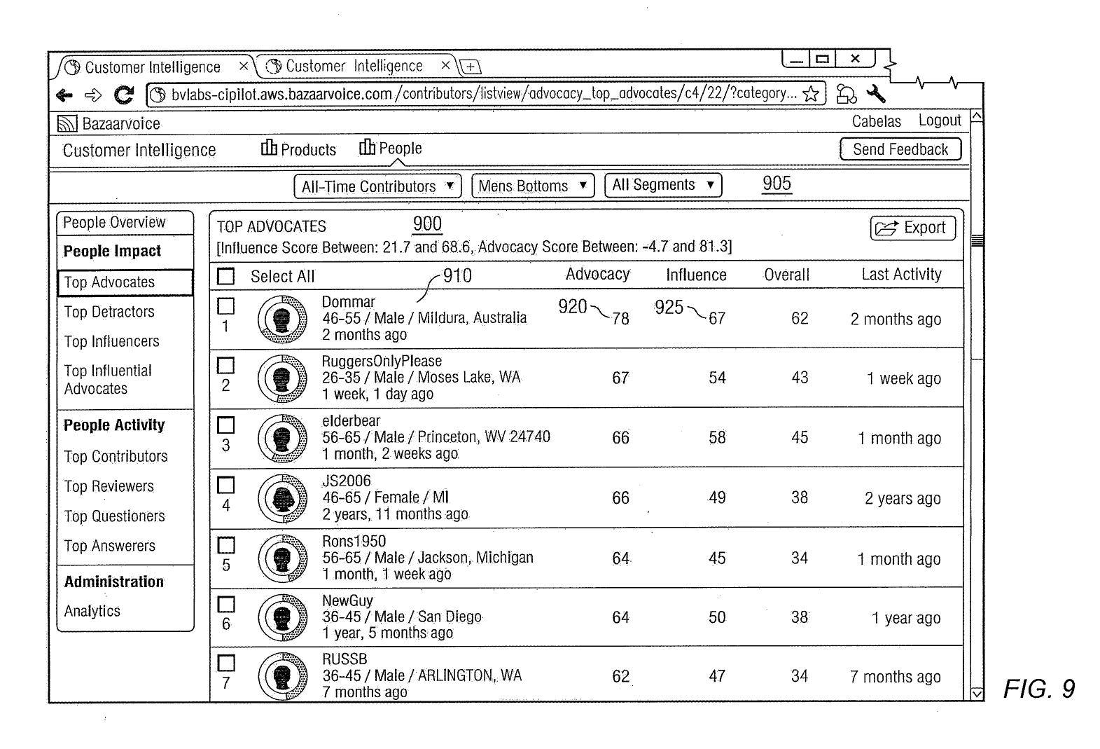

UGC 130 may be stored with a variety of metadata including, in some embodiments, user identification(s) for a user submitting the UGC, a good or service being reviewed, an identification of a web site from which the UGC was received, a relevant retailer, manufacturer, wholesaler, provider, etc. Other information besides content of the UGC itself may be determined based on a user's actions (such as the number or reviews submitted by the user, or other factors, scores, and/or metrics as discussed herein). Thus in one embodiment, data store 107 includes all information necessary to perform one or more aspects of the methods of FIGS. 6B and 7B.

Content distribution system 105 may also maintain a set of user data 140, in various embodiments, which may comprise information on users who have submitted UGC. Such information may include user names, email addresses and any other information for a user. In one embodiment, content distribution system 105 provides existing user generated content 110 and content generation tools 115 for inclusion in a web page 120, and receives recently generated user generated content 125 submitted using the content generation tool 115.

While content distribution system 105 is configured to collect user generated content for distribution and/or analysis in the embodiment of FIG. 1, there may be additional information acquired by system 105 and/or maintained by others that is also of interest. For example, a retailer, reseller, wholesaler, or other entity may maintain data stores 145 of additional user data 150, including, in various embodiments, demographic information and financial information about users. Social networking sites, web analytics providers, and others may also store information of interest which may be used in association with determining an influence metric or advocacy metric (as discussed below). Thus, in one embodiment, data correlation system 155 is configured correlate additional user information 150 with users who submitted user generated content, and may store user generated content and user data 170 in a content intelligence data store 175.

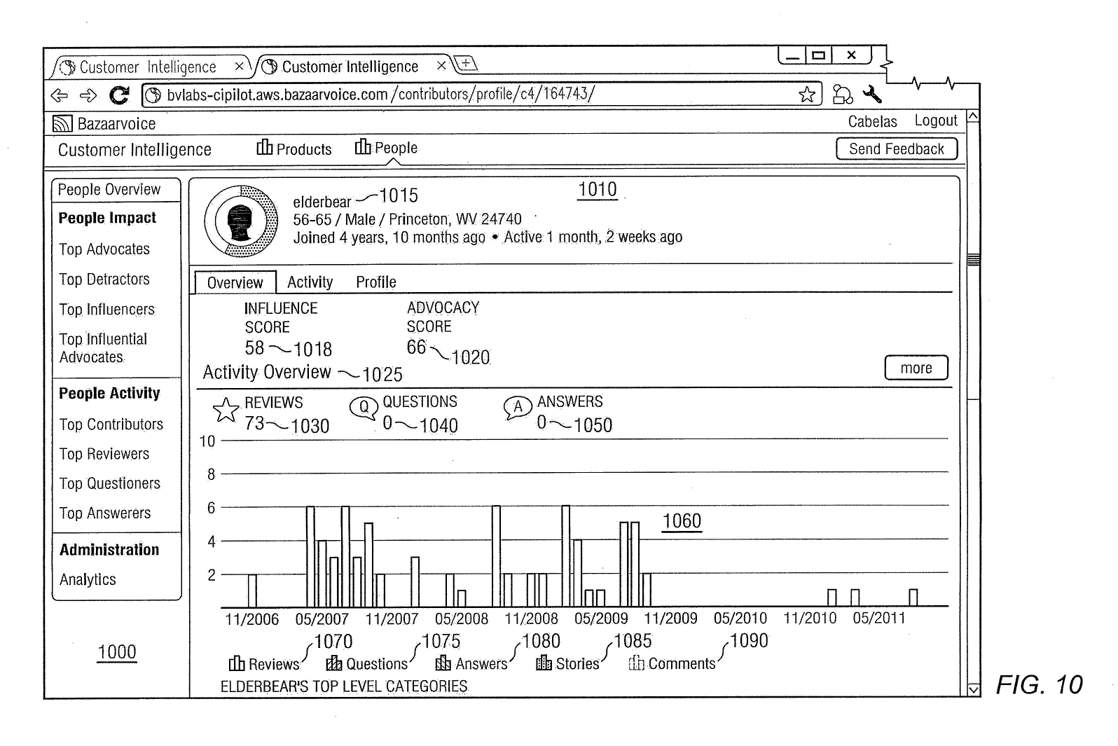

Content intelligence system 180 is configured to analyze UGC and other information to provide insight into users and their sentiments in one embodiment. Embodiments of content intelligence system 180 can identify one or more goods or services that receive the most polarized reviews, positive/negative aspects of a good or service, users who have been identified as influential, customers who are the strongest advocates of a retailer, brand, product type, manufacturer, etc., and other information that may allow a retailer, manufacturer, or other entity to make a strategic decision regarding products or customers. In some embodiments, content intelligence information may be presented through one or more web pages 185, which may include GUIs 800, 900, and/or 1000 that are depicted in FIGS. 8-10. Note that in various embodiments, content intelligence system 180, data correlation system 155 and content distribution system 155 may share hardware and/or software resources and, thus, may be implemented on the same machine or be distributed across multiple computers, while data store 107, data store 175 and data store 145 may each be distributed across multiple data stores and types of data stores and may be combined into one or more shared data stores.

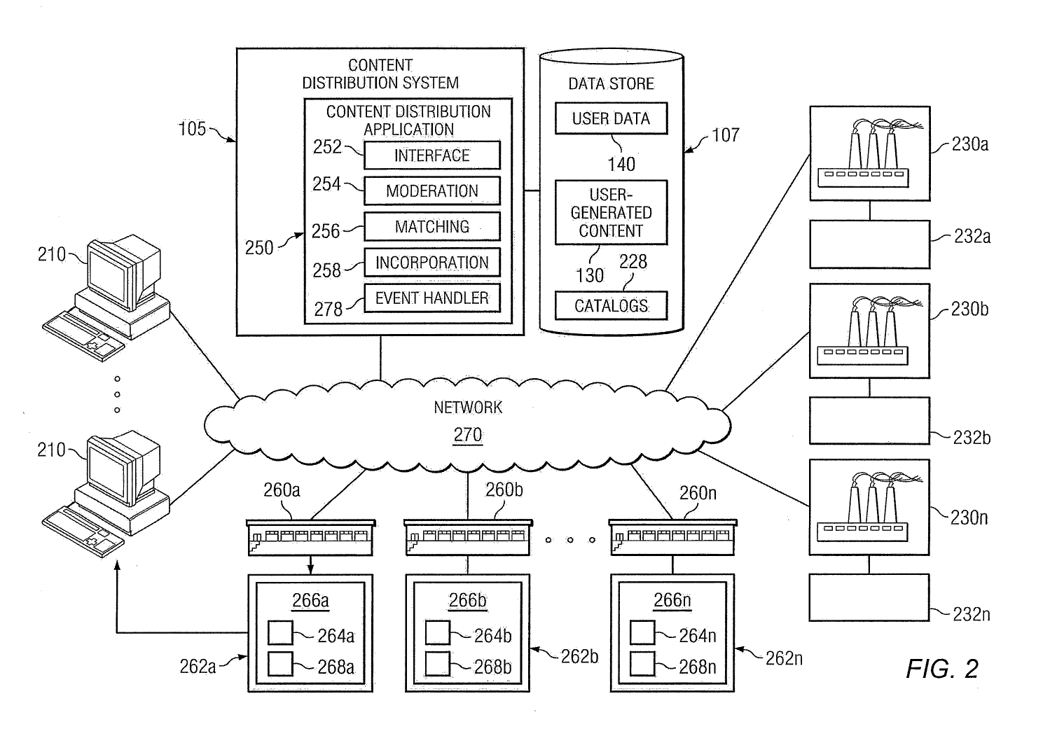

Turning now to FIG. 2, a block diagram is shown of one embodiment of a content distribution topology. Manufacturers 230 may produce, wholesale, distribute or otherwise be affiliated with the manufacturing or distribution of one or more goods or services. Retailers 260, in one embodiment, may be sales outlets for products made by one or more of manufacturers 230. Products may be provided for sale in conjunction with one or more web sites (referred to also as sites) 262 or (brick and mortar stores) provided by a retailer 260, in the embodiment of FIG. 2, such that a user at a computing devices 210 may access a web site over a network 270 in order to purchase a good or service, or perform other actions (such as submitting UGC). Network 270 includes the Internet, in various embodiments.

In some embodiments, one or more sites 262 may be affiliated with a manufacturer or other entities besides a retailer, and a site 262 may offer the ability to access UGC associated with goods or services, categories of goods or services, brands, etc., that may be manufactured, offered for sale, or otherwise associated with a retailer, manufacturer, reseller, or other entity. Site 262 also offers the ability to generate UGC in various embodiments, such as reviews, ratings, comments, problems, issues, question/answers, etc. UGC may also be generated, submitted, or received in any way that would occur to one of ordinary skill in the art. Another site 232 may be associated with a manufacturer (or a different entity associated with site 262) in various embodiments. Site 232 may be configured to include any and all functionality of site 262 as described herein, and vice versa. UGC may be collected from and displayed on sites 232 and 262 in various embodiments, and may be suitably combined to form a larger UGC data source, in one embodiment. In some embodiments, any of sites 232 and 262 may each be associated with one or more providers.

In the embodiment of FIG. 2, content distribution system 105 may include one or more computers coupled to a network 270 and a data store 107 that includes UGC 130, catalogs 228 and user data 140. Catalogs 228 may comprise a set of one or more catalogs containing relevant data for a retailer, manufacturer, distributor, or other entity. Thus in some embodiments, a catalog comprises one or category identifiers that may be associated with one or more product identifiers. Product identifiers may be, in turn, associated with a brand name, a product name, or any number of other attributes. In one embodiment, an interface is provided for an authorized user to add, combine and/or rename categories. For example, a product could be in the “LCD Monitors” category in one retailer or entity and the “19 inch Monitors” category for another retailer or other entity. Another user, could, if desired choose to consolidate these two categories into, for example, a “Monitors” category, in one embodiment.

Content distribution system 105 also includes, in one embodiment, a content distribution application 250 which comprises interface module 252, moderation module 254, a matching module 256 an event handler module 278 and an incorporation module 258. Moderation module 254 may moderate (for example, filter or otherwise select), or allow to be moderated, content or UGC which is, or is not to be, excluded or included from a data store or source, while matching module 256 may serve to match received user generated content with a particular product or category. In one embodiment, this matching process may be accomplished using catalogs 228.

UGC may be moderated by moderation module 254, in some embodiments, to determine if such content should be utilized for display on a site. This moderation process may comprise different levels of moderation, including auto processing the user generated content to identify blacklisted users or trusted users; human moderation which may include manually classifying content or content recategorization; proofreading; or almost any other type of moderation desired. According to one embodiment, moderation can include tagging reviews with tags such as “product flaw,” “product suggestion,” “customer service issue” or other tag based on the user generated content.

Note that content distribution system 105 may also include modules to collect additional information such as web analytics as described, for example, in U.S. patent application Ser. No. 12/888,559, entitled “Method and System for Collecting Data on Web Sites,” filed Sep. 23, 2010, which is hereby fully incorporated by reference. Additionally, the segregation of content distribution system 105 from site 232 or 262, as discussed above, is only one embodiment and a same entity may provide content distribution, sell products or services, or take other actions described herein with respect to various computer systems.

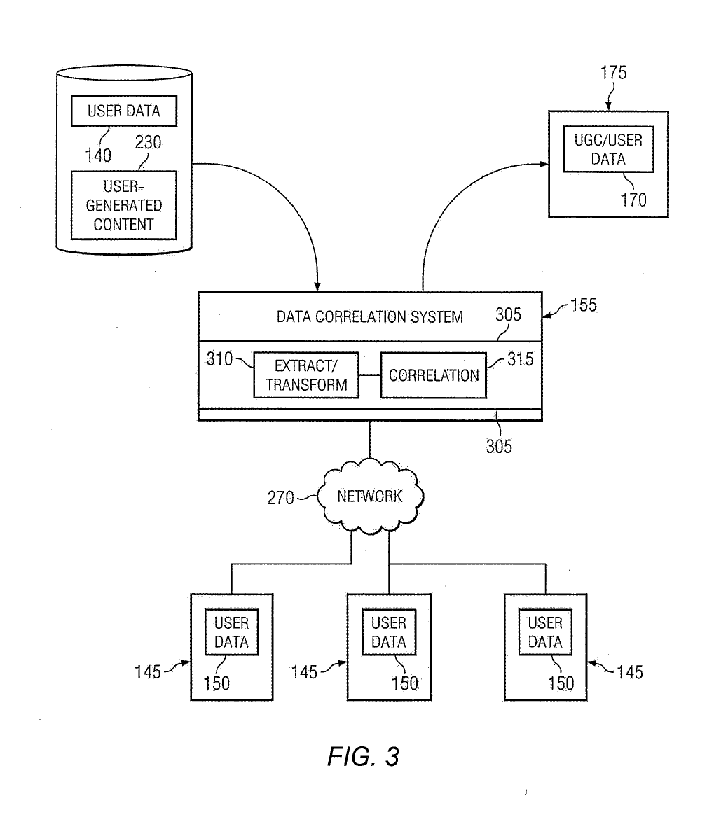

Turning now to FIG. 3, a block diagram is shown of one embodiment of a data correlation topology including data correlation system 155. Data correlation system 155 includes one or more computers coupled to a network 270 in the embodiment of FIG. 3, and also includes data store 107 and data store 175. As discussed above, data store 107 may comprise a data store of UGC, information for users who have submitted UGC, and/or related information. Data store(s) 145 may comprise additional user information 150 and/or a content intelligence data store. Data store(s) 145 may represent, for example, systems storing customer information, web analytics, social networking information or other information about users, products, retailers etc. In some cases, data store(s) 145 may be controlled by different entities than data store 107. Consequently, in some embodiments, user data 150 may not initially be associated with users who submitted UGC 130, or products referenced by the user generated content.

Thus, in one embodiment, data correlation system 155 includes a data correlation application 305 having extract/transform modules 310 and correlation module 315. Extract/transform modules 310 may extract data from data stores 107 and 145 and transform the data into a format used by data correlation application 305. Correlation module 315 may parse data to identify common information, e.g., identifying information from additional user data 150 that corresponds to users defined in user data 140 or products referenced. Correlation application 305 may store data extracted from user data 140 and additional user data 150 in a manner such that users defined in user data 140 can be linked to (correlated with) appropriate user data from additional user data 150.

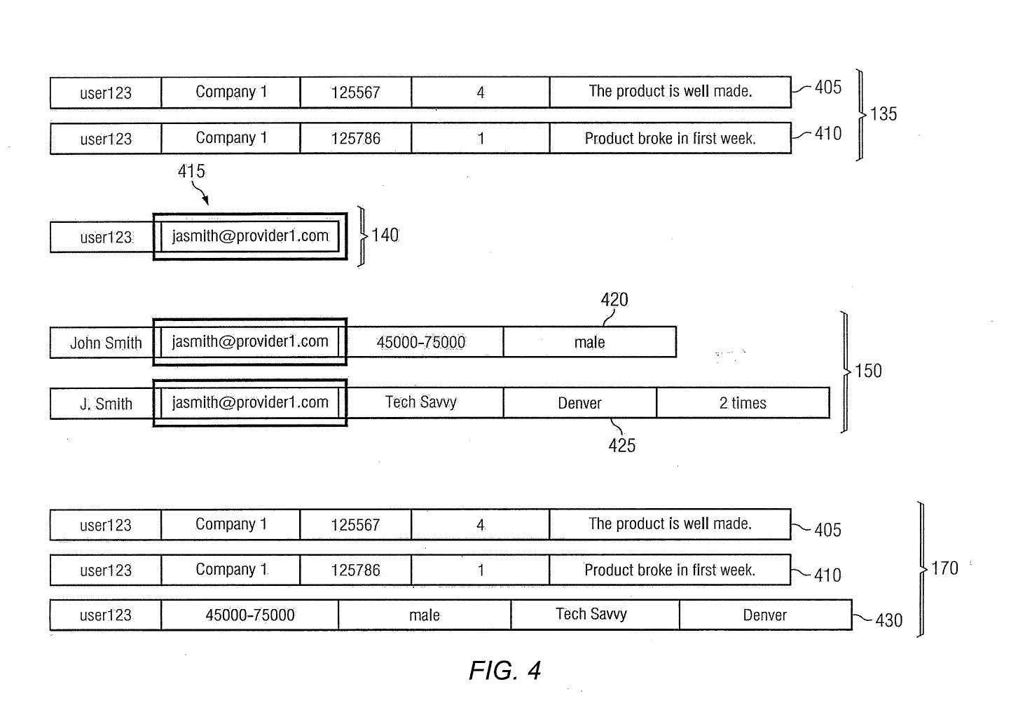

FIG. 4 is a block diagram of one embodiment related to the correlation of user information (e.g., correlating data from user data 140 with data from additional user data 150). In the embodiment of FIG. 4, records 405 and 410 for moderated user generated content 135 indicate that User123 submitted reviews on Company 1's website for products 125567 and 125786 and rated the products with four stars and one star respectively. User data 140 of content distribution system 140 further indicates, in this example, a user record 415 for User123 with an email address of jasmith@provider1.com. Records 420 and 425 are, in the embodiment shown, examples of additional user data 150 (e.g., that can be extracted from data source(s) 145 of FIG. 3). Record 420 may be a financial record of Company 1 containing information entered for customer John Smith. In this case, record 420 indicates that customer John Smith has the email address jasmith@provider1.com, an income level of $45,000-$75,000 and is male. Record 425 may be a record of information, maintained based on customer surveys, which indicates that Mr. J. Smith has the email address jasmith@provider1.com, is classified as Technologically Savvy, lives in Denver and buys products from Company 1 twice a year. Based on the email address in each record shown, in one embodiment, the data correlation system can identify that records 420 and 425 correlate to User123 who submitted the reviews of records 405 and 410. Therefore, the data correlation system may store the information that links part or all of records 420 and 425 to User123. Information about users, products, etc. that is maintained in third party databases or other sources can thus be correlated with users, products, etc., in various embodiments, providing larger data sets with which to work.

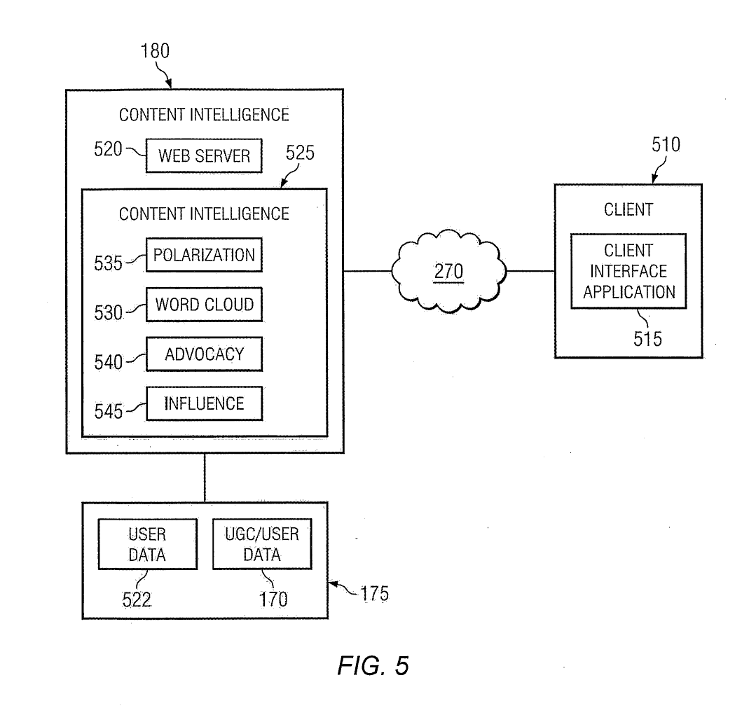

Turning now to FIG. 5, a block diagram is shown of one embodiment of a content intelligence topology including a content intelligence system 180. In the embodiment shown, content intelligence system 180 is configured to communicate with a client computer 510, e.g., via a client interface application 515. According to one embodiment, content intelligence system 180 provides a web interface such that information provided by content intelligence system 180 can be rendered in a browser-based application.

Content intelligence system 180 may access UGC and/or user data 170, which may include, in various embodiments, information regarding customer sentiment (e.g., how customers feel about products, determined through analysis of ratings and reviews), associated with individual products (e.g., by SKU number or other identifier) and user records (e.g., including, for example user name, transaction history, demographic information, financial information, social network or other third party information or other information about a user). User information 170 may also include demographic information, financial information, a social networking related score (e.g., KLOUT Score, such as provided by KLOUT, Inc.) or any other information correlated to a user who has submitted user generated content. According to one embodiment, users may be associated with segments (age, income, channel usage (e.g., manner in which the user purchases products such as direct/online only, retail only, both), income, persona (e.g., tech savvy or other arbitrary persona assigned to a user) or other segment). Segments may be derived from information submitted by users when submitting user generated content, imported from customer relationship management data, or other otherwise determined.

Content intelligence system 180 may also maintain its own user data 522 for users accessing content intelligence in one embodiment. In another embodiment, a content intelligence application 525 may include various modules to process user generated content and user data 170, including word cloud module 530, product polarization module 535, advocacy module 540 and influence module 545. For example, word cloud module 530 can analyze reviews to determine the words that have a high frequency in bad reviews of a good or service. This can be used to help identify flaws with a good or service. Conversely, word cloud module 530 can determine the words that have a high frequency in good reviews of a product, enabling identification of features that should be maintained or emphasized.

Furthermore, the average rating of a product does not always provide a full picture of how users feel about the product. Some products have a uniform sentiment regardless user characteristic (e.g., males and females rate the product 4 out of 5 stars, with very little variation). Other products may have polarized sentiment (e.g., males rate the product 2 stars, females rate the product 5 stars, with very little variation within a gender). It is useful to identify which products are polarized based on various characteristics such as gender, financial bracket or other factor. Product polarization module 535, in the embodiment shown, is configured to assess a degree of polarization of sentiment across various dimensions and provide the results in an easily discernible format. Thus, for example, product polarization module 535 can assess which products received the most polarized reviews based on, user gender, income level, defined category of user or other dimension.

In the embodiment of FIG. 5, advocacy module 540 is configured to determine an advocacy metric for a user. In various embodiments, advocacy module 540 may include any or all of the features or characteristics of advocacy module 600 as described relative to FIG. 6A. Influence module 545 is configured, in the embodiment shown, to determine a user's influence metric influence. In various embodiments, influence module 545 may include any or all of the features or characteristics of influence module 700 as described relative to FIG. 7A.

Turning now to FIG. 6A, one embodiment of advocacy module 600 is shown. Advocacy module 600 may be configured to analyze user generated content and/or other information to determine an advocacy metric that is indicative of a degree of advocacy for a particular person (e.g., an individual or group corresponding to a user account that generates UGC) for a plurality of goods or services. Example advocacy module 600 includes an advocacy type module 620 and an advocacy amount module 630 in the embodiment shown.

In one embodiment, advocacy module 600 and the various sub-modules of advocacy module 600 may be implemented as computer-readable instructions stored on any suitable computer-readable storage medium. As used herein, the term computer-readable storage medium refers to a (nontransitory, tangible) medium that is readable by a computing device or computer system, and includes magnetic, optical, and solid-state storage media such as hard drives, optical disks, DVDs, volatile or nonvolatile RAM devices, holographic storage, programmable memory, etc. The term “non-transitory” as applied to computer-readable media herein is only intended to exclude from claim scope any subject matter that is deemed to be ineligible under 35 U.S.C. §101, such as transitory (intangible) media (e.g., carrier waves per se), and is not intended to exclude any subject matter otherwise considered to be statutory. Computer-readable storage mediums can be used, in various embodiments, to store executable instructions and/or data. In some embodiments, particular functionality may be implemented by one or more software “modules”. A software module may include one or more executable files, web applications, and/or other files, and in some embodiments, and may make use of PHP, JAVASCIPT, HTML, Objective-C, JAVA, or any other suitable technology. In various embodiments, software functionality may be split across one or more modules and/or may be implemented using parallel computing techniques, while in other embodiments various software functionality may be combined in single modules. Software functionality may be implemented and/or stored on two or more computer systems (e.g., a server farm, or a front-end server and a back-end server and/or other computing systems and/or devices) in various embodiments.

Advocacy type module 620 may be configured, in various embodiments, to determine a person's type of advocacy (e.g., positive advocacy, negative advocacy) for a plurality of goods or services, category of goods or services, brand, or another entity or object based on the analyzed UGC. In the embodiment shown, advocacy type module 620 includes rating bias module 622, net promoter score module 624, and recommended bias module 626. In some embodiments, rating bias module 622 may determine how positively or negatively biased a person is with respect to sentiment toward goods or services as compared to other persons. In some embodiments, net promoter score module 624 may determine a score for the person as to the likelihood that the person would recommend the goods or services (or an entity associated with the goods or services, such as a manufacturer or seller of the goods or services). Recommendation likelihood module 626 may determine, in one embodiment, how likely a person is to recommend a particular good or service. In other embodiments, advocacy type module 620 may use one or more of rating bias module 622, net promoter score module 624, and/or recommended bias module 626 to determine the person's type of advocacy. Additional details as to the determination of the rating bias, net promoter score, and recommendation likelihood are provided below at FIG. 6B.

In the embodiment shown, advocacy amount module 630 may be configured to determine an amount of advocacy for the particular person for the goods or services based on the analyzed UGC. In the embodiment shown, advocacy amount module 630 includes social shares module 632, multimedia attachment module 634, good/service recommendation module 636, and volume module 638. In one embodiment, social shares module 632 may determine a person's propensity to share content (e.g. UGC, such as a review and/or rating) associated with the plurality of goods or services via a social networking site (e.g., via FACEBOOK, via TWITTER, LINKEDIN, etc.). In other embodiments, multimedia attachment module 634 may determine a person's propensity to associate multimedia (e.g., videos, photos, audio content) to other user generated content. Recommendations module 636, in one embodiment, may determine a person's propensity to associate other goods or services in an item of UGC regarding a particular good or service. In one embodiment, volume module 638 may determine a quantity of user generated content the person has authored for the plurality of goods or services. Advocacy amount module 630, in some embodiments, may use one or more of social shares module 632, multimedia attachment module 634, product recommendations module 636, and/or volume module 638 to determine the person's amount of advocacy. Additional details as to the determination of the rating bias, net promoter score, and recommendation likelihood are provided below at FIG. 6B. That is, in various embodiments, advocacy module 600 and/or its sub-modules may be used to implement any or all of the features described below relative to FIG. 6B.

In one embodiment, advocacy module 600 determines the advocacy metric for a particular person based on a determined advocacy type and amount. The determined advocacy metric may be modified relative to advocacy metrics of other particular persons such that the advocacy metric may be standardized on some scale (e.g., a 1-100 scale). The determined advocacy metric for the particular person and/or the advocacy metrics for other particular persons may be provided for display, examples of which can be seen in FIGS. 8-10. For example, an entity associated with one or more goods and services (e.g., seller, manufacturer, etc.) may be interested in advocacy metrics for various people to identify people to target with marketing campaigns, word-of-mouth (“WOM”) building initiatives, focus groups, and/or loyalty building initiatives (e.g., promotions and deals), etc.

Turning now to FIG. 6B, a flow chart of one embodiment of a method 650 for determining an advocacy metric for a person based on user generated content. In some embodiments, method 650 is performed by content intelligence system 180 and/or one or more components of advocacy module 600. In various embodiments, computer systems other than content intelligence system 180 may contribute to performing one or more portions of method 650 by gathering and providing information (even without actually performing a portion of method 650). In other embodiments, a system other than content intelligence system 180 may perform one or more steps of method 650.

At 660, a plurality of UGC items, authored by a particular person, about a plurality of goods or services may be received. In various embodiments, each of the plurality of UGC items may be associated with the particular person's opinion of a respective particular one of the plurality of goods or services. An opinion of a good or service may reflect a hands-on experience with that good or service (such as a purchase good and subsequent use of a product). In other instances, an opinion of a good or service may be based purely on opinion (e.g., the person may not have any direct experience with a good or service). In yet another instance, a person's opinion may be based at least partly on the hands-on experience of another person (such as a friend or relative.

UGC items may be received from a variety of sources. For instance, in various embodiments, one or more of a plurality of UGC items may be received from: a network site (e.g., official website, social network page of the entity, etc.) of an entity selling the plurality of goods or services, a network site of an entity producing or providing the plurality of goods or services, a forum (e.g., a forum directed to a particular brand, etc.), a social network site, a personal website/blog, a site affiliated with or owned by a reseller, distributor, or wholesaler, or other sources.

As used herein, the term “plurality of goods or services” may refer, in various embodiments, to two or more goods (and no services), to two or more services (and no goods), or to one or more goods and one or more services. In some embodiments, a plurality of goods or services (e.g., for which UGC has been generated) may be common to a particular category of goods or services. For example, the plurality of goods or services may be common to a type or category of good or service (such as electronics, books, household goods, performing repairs, etc.), common to a seller of a good (e.g., retailer, wholesaler, reseller, etc.). What constitutes a type and category of good or service may be defined as desired, and may be broader (e.g., mobile phones) or narrower (e.g., 4G mobile phones with 12+Megapixel cameras) in various embodiments.

In another embodiment of method 650, a plurality of UGC items may include review(s), rating(s), blog entries, other textual content, video content, image content, audio content, and/or other UGC regarding the plurality of goods or services. In one embodiment, a particular UGC item may include both a review (e.g., written testimonial-type material) and a rating (e.g., a score). In such an example, that particular UGC item may be treated as two separate UGC items or as a single item, in various embodiments. (In other words, UGC items may have multiple components, each of which may also be treated as an individual UGC item.)

In one embodiment, one or more received UGC items may be processed and/or analyzed before determining a corresponding advocacy metric. For example, textual content of a written review may be analyzed to determine an approximated rating number (e.g., if the review otherwise does not have a user-submitted rating number, or to provide another type of rating number in addition to a user-submitted rating number associated with the review, etc.). As a simple specific example, consider a UGC item that includes a description of a particular good or service. Text in the UGC item may mention the phrase “poor design” and “sluggish” within the same sentence as the name of a particular good or service to which the UGC item pertains. An analysis of the textual content of the UGC item may result in assigning the text a rating number of 2 (out of 5) for that particular good or service (as just one example). Note that if the text is explicitly accompanied by a user-submitted rating of 3 (out of 5), a different rating number of 2.5 might be assigned to the UGC item as a whole, while two separate ratings of 2 and 3, respectively, would be considered as ratings of two different components of the UGC items. In some cases, the analysis of textual content of the UGC may be used to provide a different type of rating number that, for example, uses a different scale from the user-submitted ratings (e.g., text rating number ranging from negative 10 to positive 10, user submitted ratings from 1 star to 5 stars).

As another example of content analysis for UGC items, audio and/or video content may be analyzed, in addition to (or instead of) textual content, in various embodiments. For example, a particular UGC item may be a video review of a person describing that person's opinion of a particular good or service. In such an example, video and audio may be available to analyze but text may not be available. Instead of analyzing (e.g., word/phrase analysis) textual material, the analysis of the content may include speech recognition and/or other speech analysis (e.g., intonation analysis to determine enthusiasm or disdain for the good or service, etc.) to determine a rating for the good or service from the video and audio UGC. Examples other than text analysis, speech recognition, and/or other speech analysis may be used in some embodiments, such as facial image recognition to determine the reviewer's facial expressions (e.g., enthusiasm, disdain, etc.).

As shown at 670, an advocacy metric for the particular person may be determined based on the plurality of UGC items authored by the particular person. In one embodiment, the advocacy metric is indicative of a degree of advocacy for the particular person for the plurality of goods or services. In one embodiment, degree of advocacy may include a type of advocacy, such as positive or negative advocacy. In various embodiments, the type of advocacy may be based one or more advocacy factors. Example advocacy factors include rating bias, net promoter score (“NPS”), net promoter score offset (“NPS offset”), net promoter score weight (“NPS weight”), and/or if the person is likely to recommend a given product, etc.

In various embodiments, rating bias may be based on a comparison of the plurality of UGC items authored by the particular person with a plurality of UGC items authored by at least one other person about one or more of the plurality of goods or services. One example of such a comparison may include summing, over the plurality of goods or services, a difference in the particular person's rating of a respective particular good or service and the average rating of the respective particular good or service by other persons, as shown in Eq. (1):

$$rating bias = {\sum }_{n} {rating}_{n} - avg . {rating}_{n} \qquad Eq . ( 1 )$$

In Equation (1), n represents a particular good or service, rating, represents the particular person's rating of good or service n, and average rating, represents the average rating of good or service n by other persons. As an example, rating bias equation may be a sum over the plurality of goods and services for which the particular person has generated a UGC item; thus, the rating bias may be an unbounded cumulative sum in some embodiments. Rating bias may thus represent how positively or negatively biased a person is regarding goods or services as compared to other people rating the same goods or services. Note that, as described herein, a rating bias may be calculated with respect to different sets of people who have authored UGC about different goods or services. Thus, for one product A for which a particular person has authored a UGC item, rating bias for that particular person may be calculated relative to 15 other people who also authored a UGC item. But for product B for which the particular person has authored a UGC item, rating bias may be calculated relative to 25 other people may have also authored a UGC item for product B (and the 25 other people include some, all, or none of the 15 people who may have authored UGC for product A).

In one embodiment, rating bias calculations for a particular product may not be performed unless the number of UGC items (e.g., reviews) for that particular product is above a threshold value. For instance, if a given product only has two other reviews, then it may be reasonable to assume that an “average rating” for that product is not as reliable as an “average rating” computed for a particular product having eight hundred total reviews. Therefore, if a threshold for including a good or service in ratings bias calculations is 10 UGC items, a calculated rating bias for a particular person may not reflect a good or service with less than 10 UGC items.

To give one specific non-limiting example of rating bias calculation, assume a person has reviewed products A, B, and C, giving them each ratings of 3 (out of 5 (or some other number)). Other reviewers (who may not all be the same) have given an average rating of 4.5 to product A, 3.5 to product B, and 1.8 to product C. The rating bias of a person who left ratings of “3” for all of these products would be (3−4.5)+(3−3.5)+(3−1.8)=(−1.5)+(−0.5)+(1.2)=−0.8. In this example, a negative rating bias of “−0.8” would indicate that person's reviews tend to be more negative, on average, than those of other reviewers (at least for the products calculated).

Net promoter score (or NPS) may also affect advocacy metrics. In one embodiment, NPS represents a value (e.g., on a scale of 1-10) for how likely a person is to recommend particular goods or services, or to recommend an associated entity or category (e.g., brand, seller, manufacturer, etc.). In one embodiment, as part of (or in response to) the UGC submission process for a particular good or service, the user submitting a UGC item may be asked to rate their likelihood to recommend that particular good or service, and/or an entity (e.g., brand, service provider) associated with the particular good or service. For example, a user may use a form to submit a review asking for likelihood of recommending that particular good or service to others. In such an embodiment, NPS values may potentially be received for each of the goods or services having a UGC item for that particular person. In various embodiments, a person's submission of NPS for a given good or service may be voluntary or mandatory (and thus a one to one correspondence of NPS to UGC item may not exist in at least one embodiment). In some embodiments, NPS values may alternately or additionally be calculated based on measured activities of a particular person, such as metrics relating to reposting or sending links to prior-submitted positive reviews and/or sending links to product pages.

In various embodiments, an overall NPS may be generated for a particular person for a plurality of goods or services, which may then be used in the determination of an associated type of advocacy and/or advocacy metric. For example, consider a scenario in which ten UGC items have been received from a particular person, and a respective individual NPS may also have been received (and/or calculated) for none, some, or all of the ten UGC items. The overall NPS value may then be determined based on those individual NPS values. Determination of the overall NPS value may be an average (e.g., absolute average, weighted average, or some other type of average) of the individual NPSs, a median of the individual NPSs, or some other determination made from the individual NPSs.

Continuing the ten UGC item example above, consider a scenario in which a person submitted the following individual NPS values: 6, 7, 8, 8, 8, 10, 9 (note that the person did not submit an NPS for three of the goods or services). A simple average of the NPS values yields an overall NPS of 8. Note that in the preceding example and in various embodiments, a UGC item without a corresponding individual NPS value is not be counted as a zero NPS value for the purposes of computing the average NPS.

An NPS offset may also be used in determining an advocacy metric. In various embodiments, NPS offset represents an offset for a particular person relative to a group NPS for a plurality of other persons. The NPS offset used in the determination of a type of advocacy may be an overall offset for the plurality of goods or services, which may be based on individual NPS offsets for respective ones of the plurality of goods or services or on a composite NPS offset for the plurality of goods or services. For example, if the average NPS for a population providing an NPS score for plurality of goods or services is 6, then an NPS offset for a person having an average NPS value of 8 for the plurality of goods or services may be +2. Note that an NPS offset may be positive or negative (or zero). In various embodiments, the overall NPS offset for the particular person may be determined by averaging, summing, or by performing some other operation on the individual NPS offsets for that particular person. In some embodiments, NPS (and/or an NPS offset) is modified by an NPS weight factor. The NPS weight may be determined in a variety of manners, such as based on empirical data, use of heuristics, etc.

In one embodiment, determining a type of advocacy (which may be used to determine an advocacy metric) is based on a recommendation factor for goods or services. For example, as part of the UGC submission process for a particular good or service, a user may be asked whether they are likely to recommend that particular good or service. As discussed in more detail below, in some cases the recommendation factor may alternately or additionally be calculated based on measured activities of a particular person, such as metrics relating to positive or negative comments regarding the particular good or service that the particular person may have authored in various contexts (e.g., reviews of other products, comments on social media sites). In various embodiments, a recommendation factor may be a binary value (e.g., yes, the person is likely to recommend the product or no, the person is not likely to do so), one of a discrete set of values (e.g., −1, 0, 1 corresponding to negative, neutral, and positive), or a real number. Similarly, an Advocacy Type value may reflect or be calculated using the recommendation factor.

One non-limiting example of an Advocacy Type value that is not based on the recommendation factor, but is instead calculated using the rating bias, NPS, NPS offset, and NPS weight is shown in Equation (2):

Advocacy Type=rating bias+(NPS offset+NPS)*NPS weight Eq. (2).

Note that the example of Equation 2 does not include a goods or services recommendation factor, but in another embodiment, such a factor is used.

In one embodiment, degree of advocacy may also include an amount of advocacy. In various embodiments, the amount of advocacy may be based one or more advocacy amount factors, including a sharing factor, a multimedia association factor, a recommendation factor, and/or a volume factor, etc.

A sharing factor may be indicative, in some embodiments, of a particular person's propensity to share their UGC via a social network or other platform. For example, a person may generate UGC via their social network account, or the person may link the UGC in a posting on their social network page to direct visitors of their social network page to the UGC. The propensity of a person to share content via a social network may be based on historical data regarding sharing UGC via a social network. Such historical data may be collected via web analytics data from the social network, from a network site hosting the UGC, from the actual UGC, among other examples. In one embodiment, the propensity of a person to share content via a social network may be determined based on a direct linking of a social network page (e.g., a person's page within the social network site) to the UGC item (e.g., during submission of the UGC item). For example, a user may select an option like “post this review to my FACEBOOK account.” Sharing factor may be a scaled score (e.g., a value of 8 on a scale of 1-10), a raw score (e.g., a cumulative unbounded value), a percentage (e.g., 75% of UGC items for the particular person are shared via social networks), or some other measure, in various embodiments.

In some embodiments, a multimedia association factor may be indicative of a particular person's propensity to attach or otherwise associate multimedia content (e.g., image(s), video(s), audio, etc.) to UGC items. Note that multiple multimedia attachments may be associated with a single UGC item in some examples. For instance, a person may author a review and attach four images to the review. In such an example, the multimedia association factor may take into account multiple associations for a given UGC item or it may be a binary value (e.g., does the UGC item have any multimedia associated with it?). For example, consider a scenario in which a particular person averages four multimedia attachments per UGC item but only attaches items 75% of the time. The multimedia association factor may be a value of four representing the four multimedia items per UGC item or it may be 75% representing a three out of four likelihood of having at least one multimedia item for a given UGC. As was the case with the sharing factor, the multimedia factor may be a scaled score, a raw score, a percentage, or some other measure, in various embodiments.

A recommendation factor for other goods or services is indicative, in one embodiment, of a person's propensity to recommend other goods or services in the context of a UGC item for a first good or service. For example, a given UGC item that reviews a television may also reference a specific type of cable or accessory that is recommended to be used with the television by the person who authored the review, or a remote that is not recommended to be used with the television. Both examples are a recommendation (positive or negative) of other goods or services within the context of a UGC item for a particular good or service. As was the case with the sharing factor and the multimedia factor, the recommendation may be a scaled score, a raw score, a percentage, or some other measure. As discussed above, in some embodiments a recommendation factor may alternately or additionally be based on the person's answer to a query regarding the likelihood that they will recommend a particular good or service.

A volume factor used to determine an amount of advocacy is indicative, in one embodiment, of a quantity of UGC items (or approved UGC items, such as those that have been approved by the community at large or by an administrator, etc.) that a particular person has authored. Such a volume factor may be expressed in terms of a raw number of UGC items (e.g., the particular person has authored 200 UGC items regarding the plurality of goods or services), a volume per unit of time (e.g., a rate, such as 10 UGC items per month, etc.), or a volume over a period of time (e.g., 60 in the past two months), in various embodiments.

One of more of the advocacy amount factors discussed above may be used to determine an advocacy amount as part of advocacy metric determination in various embodiments, including an embodiment according to Equation (3):

Advocacy amount=C+(social share factor+multimedia factor+recommendation factor+volume factor)*amount weight Eq. (3).

In the example equation of Equation (3), C may be a constant (e.g., 1) that may be set to any desired value according to heuristics, empirical data, etc., social share factor may be the number of shared UGC items, multimedia factor may be the number of UGC items having associated multimedia, recommendation factor may be the number of UGC items having references to other goods/service, and volume factor may be the number of approved UGC items, questions, answers, stories, comments, etc. Each of the factors listed may have their own respective weighting value, and a total amount weight may also be a different weighting factor (e.g., 0.05, 0.2, etc.).

In one embodiment, determining an advocacy metric may include using a combination of Equations (2) and (3) to generate overall advocacy points for the particular person. As one example, Eq. (2) may be multiplied by Eq. (3) resulting in overall advocacy points for the person, which may be negative, positive, or zero.

Various determinations may be made based on overall advocacy points. For example, overall advocacy points for various persons may be compared with each other to determine a maximum advocacy point total across the various persons. Accordingly, the advocacy metric may be determined for the particular person (and other persons) according to a score scaled relative to the maximum (and/or minimum) overall advocacy points. For example, for a particular person, the advocacy score may be based on that person's overall advocacy points divided by the maximum overall advocacy points resulting in a relative score. The relative score may then be scaled. As one example of scaling, the square root may be taken of the relative score with the result then multiplied by 100.

Note that the advocacy metric, including type of advocacy (e.g., which may be based on one or more of a rating bias, NPS, NPS offset, NPS weight, recommendation, etc.) and/or an amount of advocacy (e.g., based on social network sharing, multimedia attachment, product recommendations, volume, etc.), may be generated for a particular common category of goods or services. For example, the various metric factors may be generated for a subset of goods or services associated with a common manufacturer of the goods or services, seller (e.g., retailer, wholesaler, after market seller, etc.) of the goods or services, type of goods or services, etc.

As illustrated at 680, an advocacy metric may be provided to an entity associated with the plurality of goods or services. The advocacy metric may be provided via a graphical user interface, such as the example graphical user interfaces of FIGS. 8-10. As described herein, entities to which an advocacy metric is provided may include a manufacturer, seller (e.g., retailer, intermediate seller, reseller, warehouse, etc.), a third party (e.g., a marketer or analytics provider associated with a manufacturer or seller), etc. Such an entity may then use received advocacy metrics to identify persons of interest, who may be targeted with marketing campaigns, word-of-mouth (“WOM”) building initiatives, focus groups, and/or loyalty building initiatives (e.g., promotions and deals), etc. to attempt to achieve a better return on investment.

The following is a detailed example of determining an advocacy metric according to method 650. In the following detailed example, a particular person has authored UGC items that include two stories for goods, five answered questions, and other UGC items as indicated in Table. 1. Additionally, the particular person has an NPS of 10. The NPS offset in this example is −8, the amount weight of Eq. (3) is 0.5, and a value C=1.0 is used. In this detailed example, Table 1 represents UGC items authored by the person for ten goods, the average rating by others for the corresponding ten goods, whether the person has shared UGC for the corresponding ten products via social media, a number of multimedia content items that the person has associated with their UGC items, and a number of times the person has recommended other goods or services in the context of reviewing the particular product.

TABLE 1

| Rating | | | | |
|---|---|---|---|---|
| by the | | | | |
| particular | Avg. rating by | Socially | Multimedia | |
| person | other persons | shared? | associations | Recommendations |
| 5 | 4.5 | Yes | 1 | 0 |
| 5 | 4.2 | Yes | 1 | 0 |
| 4 | 2.5 | No | 2 | 0 |
| 3 | 3.1 | No | 0 | 1 |
| 5 | 3.9 | No | 0 | 1 |
| 4 | 2.3 | Yes | 0 | 0 |
| 5 | 4.0 | No | 2 | 1 |
| 5 | 3.5 | No | 0 | 1 |
| 4 | 4.9 | Yes | 0 | 0 |
| 5 | 4.1 | Yes | 0 | 0 |

Continuing this example, the rating bias for the particular person may be determined using Eq. (1) above as follows:

rating bias=(5−4.5)+(5−4.2)+(4−2.5)+(3−3.1)+(5−3.9)+(4−2.3)+(5−4.0)+(5−3.5)+(4−4.9)+(5−4.1)=8.0.

Using the calculated rating bias, and the NPS, NPS offset, and NPS weight from above, the advocacy type may be determined from Equation (2) as follows:

Advocacy type=8.0+(−8+10)*0.5=9.0

Further, the advocacy amount may be determined for the detailed example based on the share factor, multimedia factor, recommendation factor and volume factor from Table 1. For example, the share factor may be based on the five shared UGC items out of the ten they authored. Using a share weight of 2, the share factor may be 5*2=10. The multimedia factor in this example for the particular person may be based on the six multimedia associations of Table 1. Using a multimedia weight of 1, the multimedia factor may be 6*1=6.

Continuing the example of Table 1, the recommendation factor for the person may be based on the four recommendations within the ten UGC items. Using a recommendation weight of 1.0, the recommendation factor in the example may be 4*1=4. The volume factor for the person may be determined based on the ten UGC items, two stories, and five answered questions resulting in a volume factor of 10+5+2=17.

Accordingly, in the example of Table 1, Equation (3) would give the advocacy amount for the detailed example as:

Advocacy amount=1.00+(10+6+4+17)*0.05=1.9

An advocacy metric for the example of Table 1 may be based on the advocacy amount and type of advocacy, and Eq. (2) multiplied by Eq. (3) may thus result in overall advocacy points for the person of the detailed example as follows:

Overall advocacy points=9.0*1.9=17.1

Assuming in this example that the maximum overall advocacy points among various persons having a respective UGC item corresponding to at least one of the plurality of goods or services is 25, then the relative advocacy score for the particular would be 17.1/25=0.684. After scaling, the advocacy metric for the particular person may be represented as: Advocacy metric=sqrt(0.684)*100=82.7.

Turning now to FIG. 7A, one embodiment of an influence module 700 is shown. As discussed below, influence module 700 may be configured to determine an influence rating for a particular person that authors UGC items (e.g., an individual, group corresponding to a user account, or other entity that generates UGC), where the influence rating is indicative of the particular person's ability to affect consumer behavior of subsequent viewers of UGC items authored by the particular person. In one embodiment, influence module 700 and its sub-modules comprise executable instructions stored on a computer readable storage medium.

Influence module 700 is configured to determine influence ratings for people that may be based, in various embodiments, on any of a variety of metrics and/or other information. In the embodiment of FIG. 7A, module 700 is configured to determine an influence rating based on an analysis of consumer behavior, an author's level of expertise, and an author's potential reach using modules 710, 720, and 730, respectively. In other embodiments, module 700 may determine an influence rating differently—i.e., modules 710-730 may be arrange differently than shown; in some embodiments, an influence rating may be determined based on different metrics and/or information than described below. Similarly, in one embodiment, module 700 determines a single influence rating for a person that is indicative of an overall influence for that person, while in another embodiment, module 700 may generate multiple (different) influence ratings for a same person. Such ratings may be indicative of a person's influence with respect to particular categories of goods or services, for example. Thus, different influence ratings might be generated for a person if that person authored UGC items pertaining to two different categories of “lawn care services” and “laptop computers.” Influence ratings may also be generated for a person relative to different brands—e.g., a person may have an influence rating for SAMSUNG products and a different influence rating for another brand (as just one example). Influence ratings may also be generated for a person relative to a specific product or group of products—e.g., an influence rating for a person who generates UGC items about TWINKIES. In general, influence ratings may be determined with respect to any selected category, entity (e.g., manufacturer, seller, etc.), good or service, and/or combination thereof.

In one embodiment, behavior module 710 is configured to analyze consumer behavior relative to UGC items in order to determine a particular person's influence rating. Accordingly, in some embodiments, module 710 may generate a metric (e.g., one or more scores) that are indicative of consumer behavior performed responsive to viewing UGC items. Such metrics may be combined with other metrics determined by modules 720 and 730 to produce a person's influence rating as discussed below. In various embodiments, module 710 assesses consumer behavior through navigation information collected in regard to viewers. Generally speaking, collected navigation information may include, for example, indications of particular links selected by a person navigating a website, indications of particular pages or websites viewed by a person, indications of particular content (e.g., UGC items) viewed by a person, indications of how long particular content was viewed, indications of subsequently generated UGC items by a viewer of UGC items, or other information. In some embodiments, navigation information may be collected by web servers administering content, browser executable scripts, cookie information, and/or other sources (e.g., data stores, databases, etc.).

In one embodiment, website navigation module 712 is configured to analyze consumer behavior with respect to websites that display UGC items. In various embodiments, analysis by module 712 may include identifying actions performed by individuals after viewing a particular UGC item. Accordingly, in one embodiment, module 712 may determine whether an individual subsequently purchased a good or service after viewing a UGC item, and track a number of instances in which viewers have purchased goods or services after viewing particular UGC items. For example, module 712 may receive an indication that a viewer clicked a link to purchase a good after viewing a UGC item about the good and adjust a maintained counter for that UGC item. In some embodiments, tracking purchases may include tracking the purchasing of goods or services identified in a UGC item and/or the purchasing of related goods or services such as a similar good or services within the same category (or from the same brand), as well as accessory or related items (e.g., a protective case for a phone identified in a UGC item), etc.

In some embodiments, module 712 may determine whether an individual has navigated to another webpage (or another website) after viewing a UGC item, and track the number instances in which such a navigation action has been performed. In one embodiment, module 712 may track a number of instances in which an individual has generated a UGC item after viewing an initial UGC item (e.g., a comment being posted to the author of the initial UGC item, a question being asked of or answered for the author, etc.). In one embodiment, module 712 tracks a number of instances in which a viewer has identified a UGC item as being helpful or useful. For example, a website may provide the ability to rate UGC items (e.g., 1 to 5 stars), flag UGC items that are unhelpful, etc. In one embodiment, module 712 tracks the number of instances in which a viewer has added a good or service to a wish list (i.e., a list of goods or services to be potentially purchased) after viewing a particular UGC item. Accordingly, UGC items for a particular author may be scored differently dependent on particular actions performed by one or more other users—e.g. a higher score may be given for a purchasing action than another navigation action.

In one embodiment, module 712 is also configured to analyze consumer behavior while viewing a page having one or more UGC items. In some embodiments, if a page includes multiple UGC items, module 712 may track particular ones viewed by a user. In some embodiments, module 712 may also track the amount of time that a particular UGC item was viewed. Accordingly, in one embodiment, a web page may include a script executable by a browser to identify a current portion of a web page being viewed (e.g., a current position of a scroll bar within a browser). The script may relay this information to the web server for analysis (or perform some or all of such analysis locally). For example, module 712 may determine that an individual spent a particular amount of time viewing a first UGC item that was located at the bottom of a webpage in response to receiving an indication that the scroll bar was positioned at the bottom of the page for a specified amount of time. Accordingly, different UGC items may be scored differently based on how long they were viewed, where they appeared on a display, etc.

External navigation module 714 is configured to analyze consumer behavior that may occur externally to websites that display UGC items in one or more embodiments. Thus, in various embodiments, module 714 may track the number of instances in which a viewer has referenced (e.g., subsequent to viewing) a UGC item or a good or service related to a UGC item. For example, module 714 may track repostings of content from a UGC item, adding a link on another website to a UGC item, adding a link to a good or service identified in a UGC item, etc. (The frequency at which a particular UGC item is subsequently referenced may be referred to as the content velocity for that UGC item as discussed below). Module 714 may also collect behavioral information from other sources such as email databases, chat client information, social networks, etc. For example, module 714 may track a number of instances in which links to UGC items authored by a particular person have been included in emails (or other communications) of viewers.

Expertise module 720, in one embodiment, determines an expertise metric for a particular person that is indicative of how knowledgeable that person may be with respect to a particular subject or particular category, brand, good or service, manufacturer, etc. In various embodiments, module 720 analyzes content of an author's UGC items to determine an expertise level. For example, in one embodiment, module 720 may track the volume of UGC items (i.e., the number of UGC items) authored by a particular person and pertaining to a particular subject, category, etc. (which may be determined by a volume module 722, in the illustrated embodiment). Module 720 may then determine an expertise metric based on volume of UGC. Accordingly, module 720 may assign a higher expertise metric to an author that generates a greater number of UGC items on a particular subject, category, etc., than authors that generate a lower number of UGC items on the subject. In one embodiment, module 720 may also track the lengths of UGC items authored by a particular person and pertaining to particular subject (as determined by a length module 724, in the illustrated embodiment). Accordingly, module 720 may assign a higher expertise metric based on authors that have an average length for UGC items above a particular threshold than authors that are under the threshold. For example a longer length description in UGC may indicate greater thoughtfulness on the part of the reviewer.

In various embodiments, module 720 may also determine an expertise metric based on a semantic analysis of UGC items from an author (as performed by semantic analysis module 726). In one embodiment, this analysis may include analyzing the lexicon of the author relative to a particular subject, category, etc. Accordingly, authors determined to use particular jargon (i.e., vocabulary identified as being relevant to a particular subject) may be assigned a higher expertise metric than authors that do not. In one embodiment, semantic analysis may include performing a spell check and/or grammar check, and authors with frequent misspellings or grammar errors may be assigned a lower expertise metric than authors that have fewer misspellings. In some embodiments, semantic analysis may include determining the types of UGC items generated by a person—e.g., whether a UGC item is a review of a good or service, a question about a good or service, an answer to a question about a good or service, a comment about a review, etc. Accordingly, a person's expertise metric may be determined based on the types of UGC that has been authored.

In various embodiments, module 720 may determine an expertise metric based on particular websites on which an author's UGC items appear, as determined by site assessment module 728. In one embodiment, site assessment module 728 determines a respective site factor for different websites based on the potential viewership of that site (e.g., based on the relevance of a site to a particular subject, a number of viewers, an average level of expertise for those viewers, etc.). Accordingly, an author may be assigned a higher expertise metric for generating UGC items that appear on (or were submitted to) a particular set of one or more websites than authors generating UGC items that appear on (or were submitted to) another site.

Potential reach module 730, in the embodiment of FIG. 7A, is configured to determine a reach metric that is indicative of a potential audience size for viewing UGC items generated by a particular person. In some embodiments, a person's reach metric may be determined based on an analysis of that person's network size (as determined by module 732). For example, such an analysis may include identifying a number of members associated with that person on a social networking site (e.g., FACEBOOK, TWITTER, etc.), identifying a number of people present in a person's contact book (e.g., stored on a phone, at email provider, etc.), identifying a person's credentials (e.g., occupations, place of residence, or other demographic information), etc. In one embodiment, module 730 may determine a reach metric based on how frequently that person generates UGC items (as determined by module 734). Accordingly, authors determined to have a higher activity frequency may be assigned a higher reach metric than those that do not generate UGC items as frequently. In one embodiment, module 730 may determine a reach metric based on how frequently content of an author's UGC items are referenced by others (as determined by content velocity module 736). Accordingly, authors that have a higher content velocity may be assigned a higher reach metric than those that are not frequently referenced by others, in various embodiments.

As noted above, metrics determined by modules 710-730 may be combined in various embodiments to produce one or more influence ratings for a particular person. Such a rating may be computed, for example, by applying different weight values to determined metrics and summing the results to produce a total. In some embodiments, this total may be normalized and/or adjusted to fit a distribution (e.g., bell curve, etc.) in order to determine an influence rating. Any of various criteria may be used to weight determined metrics. In some embodiments, a person's reach metric may be given more weight than that person's expertise metric; in determining person's behavior metric, more weight may be given to purchasing of a good or service as opposed to adding a good or service to a wish list; in determining a person's expertise metric, the semantic analysis may be given more weight than the average number of words present in a person's UGC items; different weights may also be used based on the types UGC items generated by a person, etc. The preceding examples are non-limiting, however, and many different variations are contemplated.

As will be discussed below with respect to FIG. 8, in various embodiments, influence ratings may be presented via a graphical user interface (along with other information, such as advocacy information discussed relative to FIGS. 6A-6B). In some embodiments, a graphical presentation may include identifying particular people that have a top influence rating relative to a particular category, brand, good or service, etc. In some embodiments, a person may be identified as a top influencer if that person's rating exceeds a specified threshold, such as falling within the top 1% of influencers, being one of the ten highest ratings, etc. In other embodiments, authors may not be identified individually but rather as a member of a group having one or more common characteristics such as common demographic information. Accordingly, a particular demographic group (e.g., individuals within a certain age group, living within particular area, etc.) may be identified as having a higher influence rating than people in other demographic groups.

Turning now to FIG. 7B, a flow chart of one embodiment of a method 750 for determining an influence rating for a person is depicted. In some embodiments, method 750 is performed by content intelligence system 180 and/or one or more components of influence module 700. In various embodiments, computer systems other than content intelligence system 180 may contribute to performing one or more portions of method 750 by gathering and providing information, for example (even without actually performing a portion of method 650). In other embodiments, a system other than content intelligence system 180 may perform one or more steps of method 750.

At 760, a plurality of UGC items authored by a particular person about a plurality of goods or services is received (e.g., by system 180). As discussed above with respect to FIG. 6B, UGC items may be indicative of a particular person's opinion relative to a particular category, brand, good or service, etc. UGC items may be received from a variety of sources and include various forms of content.

At 770, consumer behavior of a plurality of individuals viewing the UGC items is analyzed. As discussed above, in various embodiments, this analysis may include identifying navigation actions corresponding to navigations performed by viewers. Such actions may include, for example, purchasing a good or service, identifying a UGC item as being helpful to other potential viewers, adding a good or service to a wish list, etc. As discussed, navigation information collected as part of this analysis may be navigation information that relates to navigations performed within websites displaying UGC items, as well as navigation information relating to navigations performed externally to such websites (e.g., causing transmission of a link for a website including a UGC item to another individual through reposting, emailing, sending a text message, etc.).

At 780, an expertise metric for a particular person is determined. As discussed above, in some embodiments, an expertise metric may be determined based on a number of UGC items authored by the particular person, an average length for UGC items authored by the particular person, a determined site factor for a website depicting one or more of the author's UGC items, a semantic analysis of UGC items, etc.

At 790, an influence rating for a particular person is determined, where the influence rating is predictive of the particular person's ability to affect behavior of subsequent viewers of UGC items authored by the particular person. In the embodiment of FIG. 7B, influence rating may be computed based on the analysis performed at 770 and based on determined expertise at 780. That is, in some embodiments, influence rating may be computed by combining metrics determined at 770 and at 780, normalizing the result, and/or shifting the result to a bell curve or other distribution. In some embodiments, influence rating may also be determined based on additional metrics such as the reach metric discussed above with respect module 730. Note also that in general, any techniques used above with respect to advocacy module 600 may be applicable to influence module 700 and method 750 (e.g., such as calculating an influence metric by comparing a score with a theoretical maximum, taking a square root and multiplying by 100, etc.).

Turning now to FIG. 8, one embodiment of a graphical user interface 800 is shown. Graphical user interface 800 may be executed in some embodiments on a computer system that is separate from the computer system(s) determining advocacy and/or influence metrics. According to various embodiments, determined advocacy and/or influence metrics may be provided for display in a graphical user interface. As shown in the embodiment of FIG. 8, graphical user interface 800 includes a graph display 805 of a number of combination advocacy/influence metrics. The x-axis of graph display 805 represents influence metrics, with the x-value of the displayed dots representing respective influence metrics of various persons. The y-axis represents advocacy metrics in the embodiment of FIG. 8, with the y-value of the displayed dots representing respective influence metrics of various persons. Thus, a dot in the upper right of graph display 805 is indicative of a high influence, positive advocate. One such example is shown at 810. In contrast, a dot in the lower left portion of graph display 805, such as shown at 820, is indicative of a low influence negative advocate. (Note that a negative advocate may also be referred to as a detractor, in some embodiments.)

Within graphical user interface 800, various selectable elements may be provided to view additional information corresponding to certain ones of the persons having advocacy and/or influence metrics. For instance, Top Advocates 830 may be an element that is selectable to display a list of one or more top advocates (e.g., as shown in the right hand column at 850). Other selectable elements may include Top Detractors 840, and Top Influencers 845.

FIG. 9 illustrates another embodiment of a graphical user interface 900 that may be displayed upon selecting the element 830 (Top Advocates) of FIG. 8. As shown, graphical user interface 900 displays a list of one or more top advocates for a particular selectable goods category 905 of “mens bottoms.” The list may display an identifier and demographic information 910, an advocacy metric 920, an influence metric 925, among other information. Similar information may also be displayed if top detractors, top influencers, top influential advocates, or some other category is selected.

FIG. 10 illustrates another embodiment of a graphical user interface 1000 that shows a detailed profile 1010 for a particular person. Graphical user interface 1000 may be presented in response to selecting a person's profile from graphical user interface 900, in one embodiment. The profile 1010 of a selected person may include user ID 1015 and corresponding advocacy score 1020 and/or influence score 1018. Profile 1010 may also include an activity overview section 1025 that may include counters or metrics for specific categories of UGC. Examples of counters/metrics include number of reviews 1030, number of questions 1040, and number of answers to questions 1050 that the person has authored/generated, in the embodiment shown. The metrics for the specific categories of UGC may be selected by the user of graphical user interface 1000 and subsequently displayed in graph 1060. Within graph 1060, the y-axis may represent a count of UGC created by the selected person, and the x-axis may represent various time periods, such as days, weeks, months or years. In various examples, other categories of UGC content such as reviews 1070, questions 1075, answers 1080, stories 1085 and comments 1090 may be selected by a user of graphical user interface 1000 and displayed on graph 1060.

### Exemplary Computer System

Turning now to FIG. 11, one embodiment of an exemplary computer system 1000 is depicted. Computer system 1100 includes a processor subsystem 1150 that is coupled to a system memory 1110 and I/O interfaces(s) 1130 via an interconnect 1120 (e.g., a system bus). I/O interface(s) 1130 are coupled to one or more I/O devices 1140. Computer system 1100 may be any of various types of devices, including, but not limited to, a server system, personal computer system, desktop computer, laptop or notebook computer, mainframe computer system, handheld computer, workstation, network computer, or a device such as a mobile phone, pager, or personal data assistant (PDA). Computer system 1100 may also be any type of networked peripheral device such as storage devices, switches, modems, routers, etc. Although a single computer system 1100 is shown for convenience, the system may also be implemented as two or more computer systems operating together.

Processor subsystem 1150 may include one or more processors or processing units. In various embodiments of computer system 1100, multiple instances of the processor subsystem may be coupled to interconnect 1120. In various embodiments, processor subsystem 1150 (or each processor unit within the subsystem) may contain a cache or other form of on-board memory. In one embodiment, processor subsystem 1150 may include one or more processors.

System memory 1110 is usable by processor subsystem 1150. System memory 1110 may be implemented using different physical memory media, such as hard disk storage, floppy disk storage, removable disk storage, flash memory, random access memory (RAM-SRAM, EDO RAM, SDRAM, DDR SDRAM, RDRAM, etc.), read only memory (PROM, EEPROM, etc.), and so on. Memory in computer system 1100 is not limited to primary storage. Rather, computer system 1100 may also include other forms of storage such as cache memory in processor subsystem 1150 and secondary storage on the I/O Devices 1140 (e.g., a hard drive, storage array, etc.). In some embodiments, these other forms of storage may also store program instructions executable by processor subsystem 1150.

I/O interfaces 1130 may be any of various types of interfaces configured to couple to and communicate with other devices, according to various embodiments. In one embodiment, I/O interface 1130 is a bridge chip (e.g., Southbridge) from a front-side to one or more back-side buses. I/O interfaces 1130 may be coupled to one or more I/O devices 1140 via one or more corresponding buses or other interfaces. Examples of I/O devices 1140 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 1100 is coupled to a network via a network interface device. The network interface device may be a wireless interface in various embodiments. In other embodiments, computer system 1100 is part of a cloud-based computing service. In general, the present disclosure is not limited to any particular type of computer architecture.

Although specific embodiments have been described herein, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure. Additionally, section or heading titles provided above in the detailed description should not be construed as limiting the disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A computer readable storage medium having stored thereon instructions that are executable by a computing device to cause the computing device to perform operations comprising:
receiving a plurality of user generated content (UGC) items authored by a particular person about a plurality of goods or services, wherein the plurality of UGC items includes a review of a particular one of the plurality of goods or services; and
determining an advocacy metric for the particular person based on the plurality of UGC items, wherein the advocacy metric is indicative of a type of advocacy for the particular person for the plurality of goods or services, and wherein the advocacy metric is relative to advocacy metrics for other persons.

2. The computer readable storage medium of claim 1, wherein the advocacy metric is further indicative of an amount of advocacy.

3. The computer readable storage medium of claim 1, wherein the type of advocacy is indicative of a bias of the particular person, wherein the bias of the particular person is determined based on a comparison of individual ones of the plurality of UGC items authored by the particular person with a plurality of UGC items, respectively authored by a plurality of other people, that relate to one or more of the plurality of goods or services.

4. The computer readable storage medium of claim 1, wherein said determining the advocacy metric includes determining a social media metric for the particular person, wherein the social media metric is indicative of a propensity of the particular person to promote UGC items on one or more social network sites.

5. A method, comprising:
a computer system receiving a plurality of user generated content (UGC) items authored by a particular person about a plurality of goods or services, wherein each of the plurality of UGC items is associated with the particular person's opinion of a respective particular one of the plurality of goods or services; and
the computer system determining an advocacy metric for the particular person based on the plurality of UGC items, wherein the advocacy metric is indicative of a degree of advocacy for the particular person for the plurality of goods or services.

6. The method of claim 5, wherein the degree of advocacy includes a type of advocacy and an amount of advocacy.

7. The method of claim 6, wherein the type of advocacy is negative advocacy.

8. The method of claim 5, wherein said determining the advocacy metric is based on a comparison of the plurality of UGC items authored by the particular person with a plurality of UGC items authored by at least one other particular person about one or more of the plurality of goods or services.

9. The method of claim 5, wherein said determining the advocacy metric is based on an analysis of content of one or more of the UGC items authored by the particular person.

10. The method of claim 5, wherein the plurality of goods or services are common to a particular category of goods or services.

11. The method of claim 5, wherein the plurality of UGC items includes a review of a particular one of the plurality of goods or services.

12. The method of claim 11, wherein the plurality of UGC items further includes a rating of the particular one of the plurality of goods or services.

13. The method of claim 5, further comprising the computer system providing the advocacy metric to an entity associated with the plurality of goods or services.

14. The method of claim 5, wherein one or more of the plurality of UGC items are received from a network site of an entity selling the plurality of goods or services.

15. A computer system, comprising:
a processor; and
a computer readable storage medium having stored thereon instructions that are executable by the computer system, using the processor, to cause the computer system to perform operations comprising:
receiving a plurality of user generated content (UGC) items authored by a particular person about a plurality of goods or services, wherein each of the plurality of UGC items is indicative of the particular person's opinion of a respective particular one of the plurality of goods or services; and
determining an advocacy metric for the particular person based on the plurality of UGC items, wherein the advocacy metric is indicative of a type and an amount of advocacy for the particular person for the plurality of goods or services.

16. The computer system of claim 15, wherein the type of advocacy for the particular person is based on a bias for the particular person, wherein the bias is determined based on a comparison of individual ones of the plurality of UGC items authored by the particular person with UGC items authored by a plurality of other persons that relate to one or more of the plurality of goods or services.

17. The computer system of claim 15, wherein the plurality of goods or services is common to a particular manufacturer of the plurality of goods or services, and wherein the advocacy metric is indicative of the particular person's degree of advocacy for the manufacturer.

18. The computer system of claim 15, wherein the type and amount of advocacy for the particular person for the plurality of goods or services is determined relative to types and amounts of advocacy for other particular persons.

19. The computer system of claim 15, wherein the plurality of UGC items includes a review of a particular one of the plurality of goods or services.

20. The computer system of claim 15, wherein determining the advocacy metric is based on an analysis of content of one or more of the UGC items authored by the particular person.
